(19) United States
(12) Patent Application Publication
(10) Pub. No.: US 2005/0086262 A1
(43) Pub. Date: Apr. 21, 2005

(54) Method and apparatus for WAP and XHTML site management

(76) Inventors: Arto Kiiskinen, San Diego, CA (US); Erkki Tanskanen, Vantaa (FI); Arto Nikupaavola, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/691,453

(22) Filed: Oct. 21, 2003

(51) Int. Cl. G06F 7/00

(52) U.S. Cl. 707/104.1

(57) ABSTRACT

A system for maintaining a WAP portal/site including different interrelated pages so as to be able to provide a requested page to a requesting terminal (19) appropriate to the terminal type (i.e. so that it can be displayed or otherwise utilized by the terminal type). The system includes: a site structure database (11) containing the WAP (or XHTML) site structure and metadata; a site management application (SMA) (12) for maintaining the site; a set of templates (14) for respective pages and for different terminal types; a content data store (16) for the different pages, possibly differing for different terminal types; and a content delivery application (CDA) (15) for providing a page requested by a terminal (19) with the page tailored to the terminal type.

### TECHNICAL FIELD

The present invention pertains to the field of Wireless Application Protocol (WAP). More particularly, the present invention pertains to providing WAP support for different kinds of user equipment devices having different capabilities.

### BACKGROUND ART

To create and maintain a Wireless Application Protocol (WAP) site that supports the many different kinds of mobile terminals/user equipment (UE) devices available today and even just now under development is a complex undertaking. Even though many of the different kinds of UE devices offer the same or similar features, there are many different kinds of UE devices from the standpoint of content and access capabilities.

A mobile WAP (or XHTML (extensible hypertext markup language)) portal—i.e. a content server hosting a WAP site—that aims to offer digital content to the many different kinds of UE devices must be maintained so as to always provide appropriate content for each different kind of UE device. Site navigation (site “surfing”) by a UE device using WAP must show only links to content that the UE device is able to utilize. Maintaining a site becomes a task of creating site structures specific for each terminal type or category. In addition, a WAP portal (site server) must display content in several languages. Furthermore, agreements with content producers often force content to be visible in only a limited set of countries, and not visible in some countries.

Currently, WML (wireless markup language) pages for a WAP portal (site server) are usually hard-coded by developers, who get requirements for the site design. As the work is manual, all pages and page groups need to be tested with actual UE devices to ensure quality. This manual stage of the publishing process is slow and error-prone, making updates to a multi-country, multi-language site that contains high amount of content, nearly impossible and always uneconomical.

What is needed is a system or tool for maintaining WAP sites and for creating new pages for existing sites. For example, what is needed is a “helper” application to help define terminal and language specific navigation structures and pages, and to alleviate or minimize the amount of testing needed prior to publishing the site structures.

### DISCLOSURE OF THE INVENTION

Accordingly, in a first aspect of the invention, a system is provided for creating and managing a site accessible as a wireless access protocol portal by terminals of different types and including a plurality of pages, characterized by: a site structure database containing data indicating how accessible content is organized at the site in terms of the pages and their interrelationships, and also indicating for each page and each terminal type a template according to which content for the page is to be provided; and a site management application for maintaining the site structure database.

In accord with the first aspect of the invention, the system may also be such as to provide access to the wireless access protocol portal and, relatedly, may be further characterized by: a templates data store including templates according to which content for the pages is to be provided for different terminal types; a content data store including content for the pages, possibly differing for the different terminal types; and a content delivery application, responsive to a request for a page from a terminal of one or another of the terminal types, for creating the requested page at runtime based on a terminal type included in the request, using information retrieved from the site structure database, information retrieved from the templates data store, and information retrieved from the content data store, all of the information indexed by information included in the request and indicating the page and the terminal type.

In a second aspect of the invention, a method is provided for creating and managing a site accessible as a wireless access protocol portal by terminals of different types and including a plurality of pages, characterized by: a step in which a site structure database is provided containing data indicating how accessible content is organized at the site in terms of the pages and their interrelationships, and also indicating for each page and each terminal type a template according to which content for the page is to be provided; and a step in which a site management application maintains the site structure database.

In accord with the second aspect of the invention, the method may also be such as to provide access to the wireless access protocol portal and may be further characterized by: a step in which a templates data store is provided including templates according to which content for the pages is to be provided for different terminal types; a step in which a content data store is provided including content for the pages, possibly differing for the different terminal types; and a step in which a content delivery application, in response to a request for a page from a terminal of one or another of the terminal types, creates the requested page at runtime based on a terminal type included in the request, using information retrieved from the site structure database, information retrieved from the templates data store, and information retrieved from the content data store, all of the information indexed by information included in the request and indicating the page and the terminal type.

In a third aspect of the invention, a computer program product is provided comprising: a computer readable storage structure embodying computer program code thereon for execution by one or more computer processors, with said computer program code characterized in that it includes instructions for performing the steps of a method according to the second aspect of the invention.

Thus, the invention provides a tool and a corresponding engine for creating and maintaining a WAP portal. With the tool-based solution provided by the invention, there is no need to test WAP pages, since templates for the WAP pages are tested (for display be UE devices). Also, there is no coding to create new pages or to modify existing ones, and so non-technical people can manage a WAP portal using the invention. Also, still, WAP portal (site) changes can be made more quickly using the invention. Relatedly, site changes need not be built to releases; one can change a site at any time using coding-based changes (allowing bundling changes into large chunks of changes). The engine allows automating site changes.

Some site change logic can be built into the tool. For example, the site management application (SMA) can be programmed to change the site every day or every week automatically. The data and change logic is programmed into the site using the SMA, and the SMA then automatically updates the site structure database (SSDB) accordingly. To do this with existing tools would require assigning a person to continually do this kind of work.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of the a system for creating and maintaining a WAP portal, according to the invention, including a SMA (Site Management Application) and CDA (Content Delivery Application).

FIG. 2 is a logic schematic of the CDA.

### BEST MODE FOR CARRYING OUT THE INVENTION

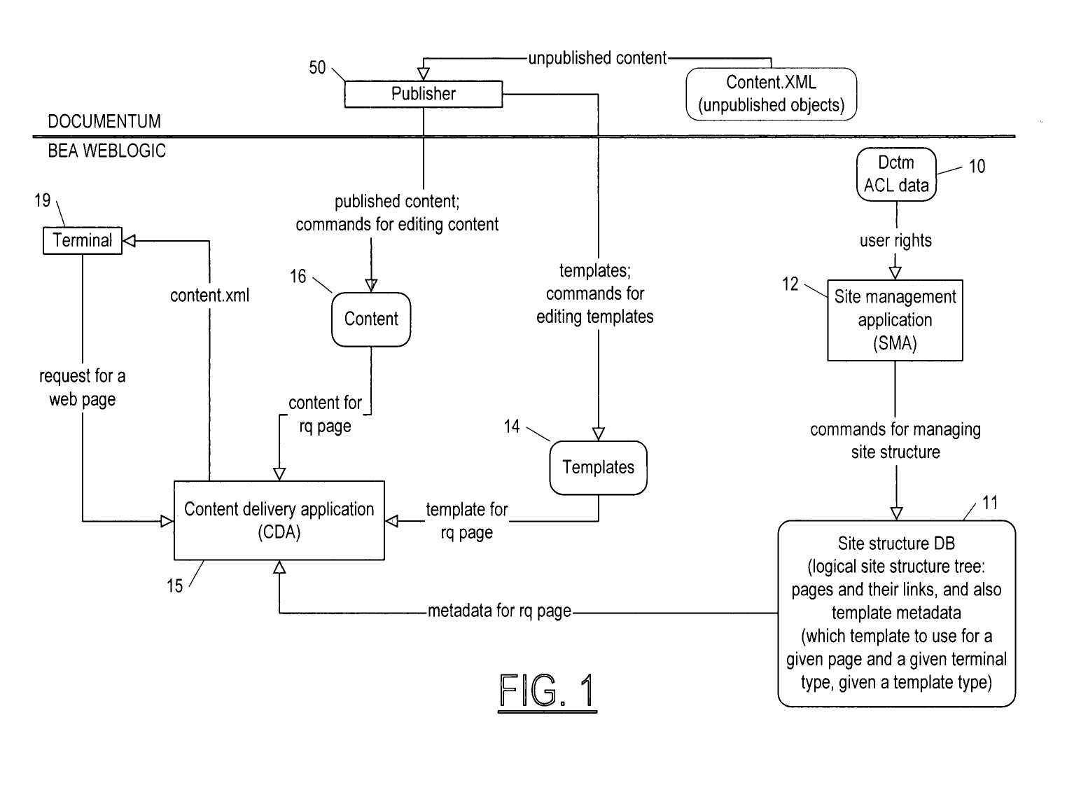

Referring now to FIG. 1, the invention provides a site management application (SMA) 12 for maintaining a WAP (or XHTML) site providing content as one or more pages (after content for the pages of the site is provided by one or another mechanism not the subject of the invention), and a content delivery application (CDA) 15 for responding to a request from a terminal 19 for a page of the site. The content (and corresponding content metadata) is first stored in a content data store 16 by use of a so-called publisher application 50, and is of two kinds: text and graphics on the one hand; and digital content—i.e. sellable content such as a ringing tone or operator logo—on the other hand. Another process (not shown), or possibly the publisher application 50 or even the SMA 12, provides initial templates for a templates data store 14; the templates stored there define how the content of the different pages is displayed on different kinds of terminals. The overall structure of the site, including how the different pages link to each other, is stored in a site structure database (SSDB) 11, which is maintained by the SMA 11 and used by the CDA 15 in responding to a request from the terminal 19 for a page.

The publisher application 50 may be part of a content management system such as Documentum—available from Documentum, Inc., of Pleasanton, Calif.,—and as mentioned, is used to provide the content stored in the content data store 16. Documentum, Inc., provides so-called enterprise content management solutions that enable people to collaboratively create, manage, deliver and archive content (data and its organization) that drives business operations—content such as documents and discussions, email, Web pages, records and rich media—using one common content platform and repository. Before objects are visible on a site, the objects are said to be “published,” meaning that the objects have undergone the content management workflow and are approved. Thus, as mentioned, the invention includes a publishing process/application 50, which has as input unpublished objects 13—content items and corresponding metadata in .xml format—and which provides as an output published objects (also content items and corresponding metadata in .xml format). The publishing application 50, or another separate application (not shown), typically manages/maintains the content data store 16 and also, as mentioned, may provide and also maintain the templates stored in the templates data store 14, as indicated in FIG. 1, but the SMA 12 too can be adapted to maintain the content data store 16 and the templates data store 14 (or another application, not shown, can be used).

The SMA 12 is a management tool used to indicate (in the SSDB 11) which pages and links can be shown to different types of terminals (taking care to prevent the CDA from showing to a terminal a link to a page that cannot be displayed for the terminal), and to indicate, for each terminal type and page, which template to use. A user uses the SMA to create a logical site structure tree, add, edit, and delete pages in it, as well as to provide rules according to which pages are shown to the terminals. The SMA 12 can be used to manage different logical sites, i.e. it is not bound to or specific to any one site. The SSDB 11 also includes template metadata, such as visibility rules (i.e. whether a page can be displayed for a given terminal/phone type).

The CDA 15 is used to provide to terminals the pages requested by the terminals in a form suitable for the requesting terminals. Thus, when a request from the terminal 19 for a particular page is received by the CDA 15, it figures out what content and which links on the page are suitable for the terminal 19, based on information in the request indicating the type of terminal, and also information stored in the SSDB 11 indicating what template to use for the indicated terminal. It then retrieves the template from the templates data store 14 and retrieves the content (digital/graphical and textual) from the content data store 16, puts them together—i.e. creates the page to be provided—and sends the page to the terminal. The CDA 15 is an application provided e.g. as a component of a BEA weblogic server, available from BEA Systems, Inc., of San Jose, Calif. (A BEA weblogic server is an application infrastructure for developing, integrating, securing, and managing distributed Java applications.)

Still referring to FIG. 1, in maintaining the SSDB 11, the SMA 12 refers to a so-called Documentum ACL (Access Control List) database 19, an implementation-specific database handling Documentum user-access rights, to determine what maintenance a user has authority to perform. In other words, the ACL database 19 indicates to the SMA 12 the limited rights a user has in using the SMA 12 to alter the SSDB 11; e.g. a user might be given rights to change only certain branches in a navigation tree.

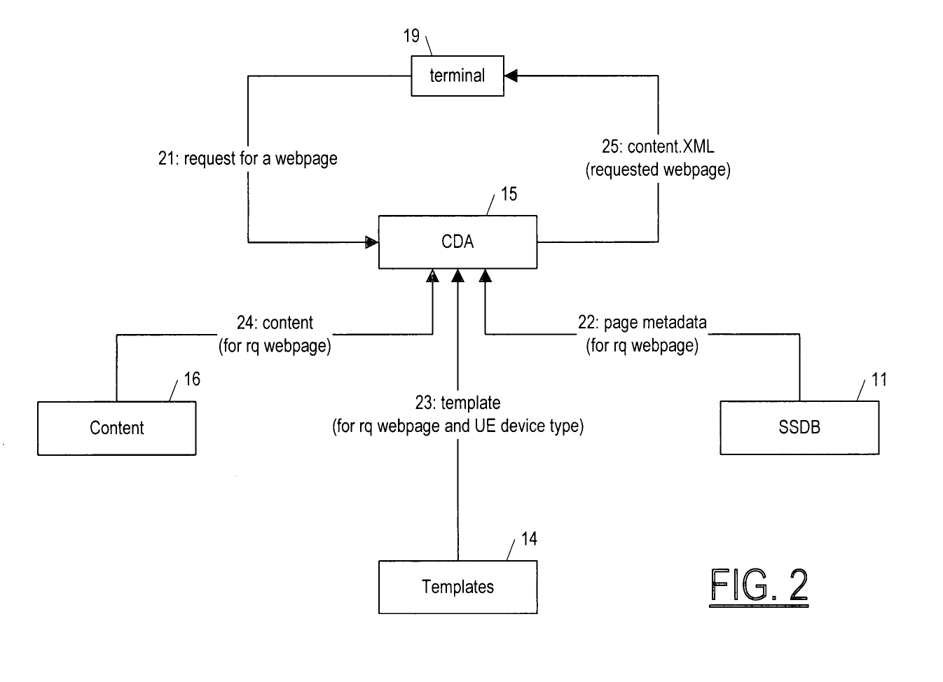

Referring now to FIG. 2, operation of the CDA 15 provided by the invention is shown in case of it receiving from the terminal 19 a data flow 21 indicating a request for a page (or, in general, some content) and identifying the page requested with a pageID. In response, in a next data flow 22, the CDA queries the site structure data/SSDB 11 and retrieves information about the requested page, and in particular: the template type of the requested page, the content selection(s) for the page, and navigation information (parent page, child pages, horizontal links) for the page. In a next data flow 23, the CDA queries the templates data store 14 with pageID and retrieves the template to be used for the page indicated by pageID. (The template retrieved is a template in a set of templates all associated with the same pageID, and selected from the set based on user-agent (UA) information provided by the terminal 19 as part of the request for the page.) In a next data flow 24, the CDA queries the content data store 16 and retrieves the content for the page indicated by pageID. (In doing so, the CDA uses the UA information included in the request from the terminal 19 to possibly select only some of the content associated with the indicated pageID because terminals of the type indicated by the UA information may not be able to display all content associated with pageID. To allow for such a possibility, in some embodiments the content data store 16 uses as indices to content in the content data store 16 both a pageID index as well as a terminal type.) Having retrieved the content and template for the requested page for the terminal type indicated in the UA information included in the request for the page, the CDA 15 assembles the page as an XML document, and then, in a final data flow 25, the CDA provides the requested page as an XML document to the terminal 19.

The invention can be implemented in many different ways. In some embodiments, the SMA 12 is a remote access administration tool, i.e. it can be accessed by users remotely, such as over the Internet. Also in some embodiments, the CDA 15 may execute in a runtime environment, (i.e. it acts autonomously, without participation by a user). Also in some embodiments, databases that the CDA accesses may be cached (i.e. so that actual reading and writing does not occur immediately, allowing for faster execution).

As shown above, the publisher 50 (a content management application—such as a Documentum-provided content management application—publishes the content for the pages of a site in XML format for the CDA 15 to use, and the publisher 50 is distinct from the SMA 12. Alternatively, the publisher functionality can be built into the SMA 12. Optimally, the SMA is the only tool used by a user in creating and managing a WAP portal, and either it contains publisher/content management functionality, or acts as a front end to such functionality.

The invention has been described in terms (primarily) of modules of a computer-based system. The invention also comprehends a method including steps corresponding to the above-described functionality of the various above-mentioned modules. Thus, for each module described above, there can be one or more steps of a method according to the invention, although it is also possible for there to be several different steps corresponding to a single module. Besides a method, the invention also encompasses a computer program product including a computer readable storage structure embodying computer program code—i.e. software or firmware—thereon for execution by one or more computer processors.

It is to be understood that the above-described arrangements are only illustrative of the application of the principles of the present invention. Those skilled in the art may devise numerous modifications and alternative arrangements without departing from the scope of the present invention, and the appended claims are intended to cover such modifications and arrangements.

1. A system for creating and managing a site accessible as a wireless access protocol portal by terminals of different types and including a plurality of pages, characterized by:
a site structure database (11) containing data indicating how accessible content is organized at the site in terms of the pages and their interrelationships, and also indicating for each page and each terminal type a template according to which content for the page is to be provided; and
a site management application (12) for maintaining the site structure database (11).

2. A system as in claim 1, also for providing access to the wireless access protocol portal and further characterized by:
a templates data store (14) including templates according to which content for the pages is to be provided for different terminal types;
a content data store (16) including content for the pages, possibly differing for the different terminal types; and
a content delivery application (15), responsive to a request for a page from a terminal of one or another of the terminal types, for creating the requested page at runtime based on a terminal type included in the request, using information retrieved from the site structure database (11), information retrieved from the templates data store (14), and information retrieved from the content data store (16), all of the information indexed by information included in the request and indicating the page and the terminal type.

3. A method for creating and managing a site accessible as a wireless access protocol portal by terminals of different types and including a plurality of pages, characterized by:
a step in which a site structure database (11) is provided containing data indicating how accessible content is organized at the site in terms of the pages and their interrelationships, and also indicating for each page and each terminal type a template according to which content for the page is to be provided; and
a step in which a site management application (12) maintains the site structure database (11).

4. A method as in claim 3, also for providing access to the wireless access protocol portal and further characterized by:
a step in which a templates data store (14) is provided including templates according to which content for the pages is to be provided for different terminal types;
a step in which a content data store (16) is provided including content for the pages, possibly differing for the different terminal types; and
a step in which a content delivery application (15), in response to a request for a page from a terminal of one or another of the terminal types, creates the requested page at runtime based on a terminal type included in the request, using information retrieved from the site structure database (11), information retrieved from the templates data store (14), and information retrieved from the content data store (16), all of the information indexed by information included in the request and indicating the page and the terminal type.

5. A computer program product comprising: a computer readable storage structure embodying computer program code thereon for execution by one or more computer processors, with said computer program code characterized in that it includes instructions for performing the steps of the method of claim 3.

6. A computer program product comprising: a computer readable storage structure embodying computer program code thereon for execution by one or more computer processors, with said computer program code characterized in that it includes instructions for performing the steps of the method of claim 4.
